(19) United States
(12) Patent Application Publication
(10) Pub. No.: US 2026/0091734 A1
(43) Pub. Date: Apr. 2, 2026

(54) EXPANDABLE COMPARTMENT FOR A VEHICLE

(71) Applicant: Ford Global Technologies, LLC, Dearborn, MI (US)

(72) Inventors: Angelica Patricia Godinez Huerta, Cuautitlán Izcalli (MX); Karla Daniela Decena Quirino, Ixtapaluca (MX)

(73) Assignee: Ford Global Technologies, LLC, Dearborn, MI (US)

(21) Appl. No.: 18/901,017

(22) Filed: Sep. 30, 2024

(51) Int. Cl. B60R 7/02; B60R 11/00

(52) U.S. Cl. CPC B60R 7/02; B60R 11/00; B60R 2011/0036; B60R 2011/0084

(57) ABSTRACT

An expandable storage compartment for use on a vehicle has an expandable frame comprising a plurality of telescoping assemblies moveable between a contracted configuration and an expanded configuration. A flexible housing extends around at least a portion of the frame to define a pair of sidewalls and a rear wall that conform to a size of the frame. A rigid top is coupled to the frame and defining a top wall, and a rigid bottom wall defining a floor is coupled to the frame. The frame moves the flexible material between the contracted configuration and the expanded configuration.

### FIELD OF THE DISCLOSURE

The present disclosure generally relates to a compartment for storing cargo items on a vehicle, and more particularly relates to an expandable compartment that may be adjusted in size, particularly for use on a motor vehicle.

### BACKGROUND OF THE DISCLOSURE

Motor vehicles are commonly equipped with various storage compartments for storing cargo on board the vehicle. For example, storage compartments may be provided in the center console, the glovebox and in the rear cargo area. It may be desirable to provide for a storage compartment that is adjustable in size to accommodate use in other areas within the vehicle such as within a cargo area.

### SUMMARY OF THE DISCLOSURE

According to a first aspect of the present disclosure, an expandable storage compartment for use on a vehicle has an expandable frame comprising a plurality of telescoping assemblies moveable between a contracted configuration and an expanded configuration. A flexible housing extends around at least a portion of the frame and defines a pair of sidewalls and a rear wall that conform to a size of the frame. A rigid top is coupled to the frame and defines a top wall, and a rigid bottom wall defining a floor is coupled to the frame. The frame and the flexible housing are adjustable between the contracted configuration and the expanded configuration.

Embodiments of the first aspect of the present disclosure can include any one or a combination of the following features:
the frame comprises a first telescoping assembly and a second telescoping assembly;
the first telescoping assembly includes a first pair of telescoping tubes and the second telescoping assembly includes a second pair of telescoping tubes;
each of the first and second telescoping assemblies include a pair of upper tubes matingly engaging a pair of lower tubes;
a plurality of tube retainers on the pair of sidewalls configured to connect the first and second telescoping assemblies to the pair of sidewalls;
an expandable shelf having flexible sidewalls connected to the rigid top, the shelf moveable between a contracted position stored proximate to a lower surface of the rigid top and an expanded position extending vertically downward from the top and supported by the sidewalls;
the flexible sidewalls comprise a fabric;
the flexible housing comprises a fabric;
a net provided on a front wall;
the net is connected to the flexible material via a zipper; and
the zipper includes a first zipper and a second zipper on the pair of sidewalls.

According to a second aspect of the present disclosure, an expandable storage compartment for use on a vehicle has an expandable frame comprising a first and second telescoping assemblies moveable between a contracted configuration and an expanded configuration. A flexible housing extends around at least a portion of the frame and defines a pair of sidewalls and a rear wall that conform to a size of the frame. A rigid top is coupled to the frame to define a top wall, and a rigid bottom wall defining a floor is coupled to the frame. The frame and the flexible housing are adjustable between the contracted configuration and the expanded configuration. An expandable shelf has flexible hanging sidewalls connected to the rigid top. The shelf is moveable between a contracted position stored proximate to a lower surface of the rigid top and an expanded position extending vertically downward from the top and supported by the hanging sidewalls.

Embodiments of the second aspect of the present disclosure can include any one or a combination of the following features:
the first telescoping assembly includes a first pair of telescoping tubes and the second telescoping assembly includes a second pair of telescoping tubes;
each of the first and second telescoping assemblies include a pair of upper tubes matingly engaging a pair of lower tubes;
a plurality of tube retainers on the pair of sidewalls configured to connect the first and second telescoping assemblies to the pair of sidewalls;
the flexible sidewalls comprise a fabric;
the flexible housing comprises a fabric;
a net provided on a front wall;
the net is connected to the flexible material via a zipper; and
the zipper includes a first zipper and a second zipper on the pair of sidewalls.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a rear perspective view of the rear end portion of a motor vehicle with a liftgate open and illustrating an expandable storage compartment in the rear cargo area, according to one example;

FIG. 2 is a front elevated perspective view of the expandable storage compartment in a first size contracted configuration;

FIG. 2A is an elevated perspective view of the expandable storage compartment having a net covering a front portion;

FIG. 3 is an elevated perspective view of the expandable storage compartment expanded into a second size expanded configuration;

FIG. 3A is an elevated perspective view of the expandable storage compartment in the second size expanded configuration with the net further extended over the front portion;

FIG. 4 is an elevated perspective view of the expandable storage compartment in the second size expanded configuration and further having a drop down shelf deployed;

FIG. 4A is an elevated perspective view of the expandable storage compartment showing FIG. 4 further with the net expanded and covering the front portion thereof;

FIG. 5 is an elevated perspective view of the expandable storage compartment as shown in FIG. 4 with a portion of the net unzipped;

FIG. 6 is an elevated perspective view of the expandable storage compartment in the second expanded size configuration with cargo items exposed on the bottom and middle shelves; and

FIG. 7 is an exploded view of the expandable storage compartment.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

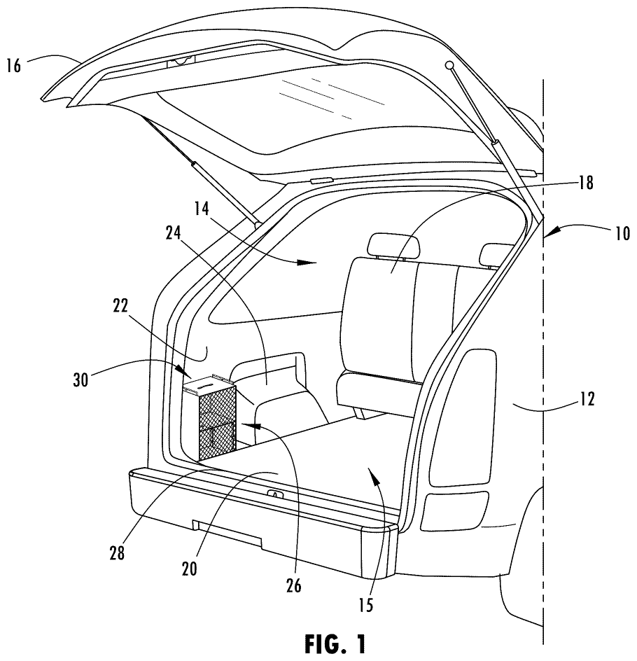

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an expandable storage compartment for use on a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-7, an expandable storage compartment 30 is shown for use in a vehicle 10, such as a motor vehicle to hold cargo items. The expandable storage compartment 30 may be expanded and contracted to fit within different spaces and to hold different numbers and size cargo items, such as small objects, within the cabin interior of the vehicle 10. The expandable storage compartment 30 has an expandable frame comprising a plurality of telescoping members moveable between contracted and expanded frame sizes, and a flexible housing extending around at least a portion of the frame to define a pair of sidewalls and a rear wall that conform to the size of the frame. The expandable storage compartment also includes a rigid top coupled to the frame and defining a top wall and a rigid bottom defining a floor and coupled to the frame, wherein the frame moves flexible material defining housing walls between the contracted and expanded configurations.

Referring specifically to FIG. 1, the expandable storage compartment 30 is shown located in a rear portion of the cabin interior 14 generally within a rear cargo area 15. The vehicle 10 may be a motor vehicle such as a wheeled automotive vehicle generally configured with passenger seats 18 for transporting one or more passengers and cargo space for transporting cargo. The motor vehicle 10 has a plurality of road wheels and a vehicle body 12 that generally defines a passenger compartment for the cabin interior 14. The cabin interior 14 has a seating area containing the seats 18 and a rear cargo area 15 generally located rearward of the seating area 18. The vehicle body 12 generally includes body panels, side entry doors, a roof, and a rear liftgate 16 at the rear end that serves as a rear access door that is configured to move to an open position to allow access to the rear cargo area from the rear end of the motor vehicle 10.

The cabin interior 14 is shown having an arrangement of rear row passenger seats 18 which typically are located rearward of a front row of passenger seats that typically includes the driver's seat and the passenger seat. The motor vehicle 10 may include additional rows of seating as is common for a large van or bus, for example, often with a rear cargo space rearward of the rearmost row of seating. It should be appreciated that the motor vehicle 10 may be a motor vehicle such as a wheeled car, truck, SUV, van or bus, for example, having one or more cargo areas available for receiving the expandable storage compartment 30.

Located behind the rear row of seating 18 is the rear cargo area 15 which extends towards the rear end of the motor vehicle 10. The liftgate 16 closes the door opening 28 at the rear end and in the closed position may expose the rear cargo area 15 in the open position such to allow access to the rear cargo area 15 as is shown in FIG. 1. When the liftgate 16 is in the open position, the expandable storage compartment 30 may be accessed along with other portions of the cabin interior 14, particularly within the rear cargo area 15. In the example shown, the expandable storage compartment 30 is shown supported on the floor 20 located between a rear wheel well 24 and the door opening 28 defining the rear end of the vehicle 10 and abutting up against an interior sidewall 22 of the cabin interior 14. The expandable storage compartment 30 may be attached to the floor 20, interior sidewall 22 and/or any other support structure via one or more tethers and/or fasteners. It should be appreciated that the expandable storage compartment 30 may be located elsewhere in the vehicle 10, according to other examples. As such, the expandable storage compartment 30 may be adjustably configured to fit within an available space and may provide additional compartment space for holding cargo items, particularly for holding smaller objects of varying sizes in an organized manner.

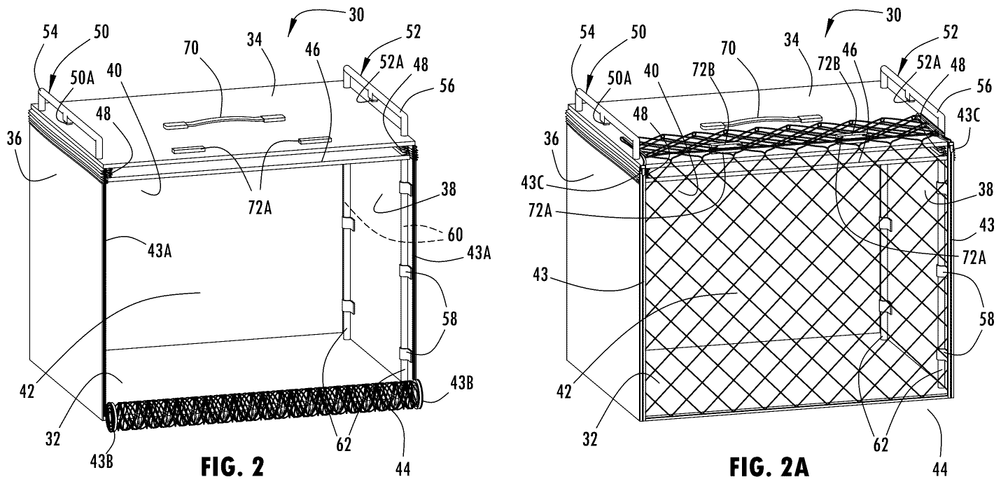

The expandable storage compartment 30 is shown in FIGS. 2 and 2A in a first size contracted configuration. The expandable storage compartment 30 has a rigid top 34 and a rigid bottom 32 which are generally planar and arranged parallel to one another. The rigid top 34 and rigid bottom 32 may be formed of a polymeric material, for example. The expandable storage compartment 30 also has a left-side wall 36, a right-side wall 38, and a rear wall 40. It should be appreciated that each of the sidewalls 36 and 38 and rear wall 40 may be made of a flexible material, such as a cloth or fabric, according to one embodiment. According to other embodiments, the sidewalls 36 and 38 and rear wall 40 may be made of a more rigid material that contracts and expands. The flexible sidewalls may fold up on the upper portion when in the contracted configuration.

The front side of the expandable storage compartment 30 has an opening 42 on the front side which is shown in FIG. 2 in an open exposed position and which may be covered with a net 44 which may be in the form of a mesh as seen in FIG. 2A. The net 44 may be attached to the front side of the side walls 36 and 38 within a zipper 43. The net 44 may be wound up into a roll onto itself or another object such as a roller, for example, when not employed to cover the front side opening 42.

The expandable storage compartment 30 includes a pair of telescoping assemblies that define an adjustable height frame including a first telescoping assembly 50 connected to the left side wall 36 on the left side and a second telescoping assembly 52 connected to the right side wall 38 on the right side. The telescoping assemblies 50 and 52 include telescoping rods or tubes that may slide relative to each other to expand or contract in size to adjust the height of the expandable storage compartment 30. The first and second telescoping assemblies 50 and 52 are shown in FIGS. 2 and 2A in the fully contracted position having the shortest height. Also, in this configuration, a middle shelf 46 is shown in a stowed position parallel and proximate to the lower side of the top 34 and having fabric sidewalls 48 folded in a compressed state. The middle shelf 46 may be a rigid planar sheet such as a polymeric sheet, for example. The rigid top 34 further includes a handle 70 which may have two connection ends and a middle handle portion configured to be engaged by the hand of a user to handle and transport the expandable storage compartment 30.

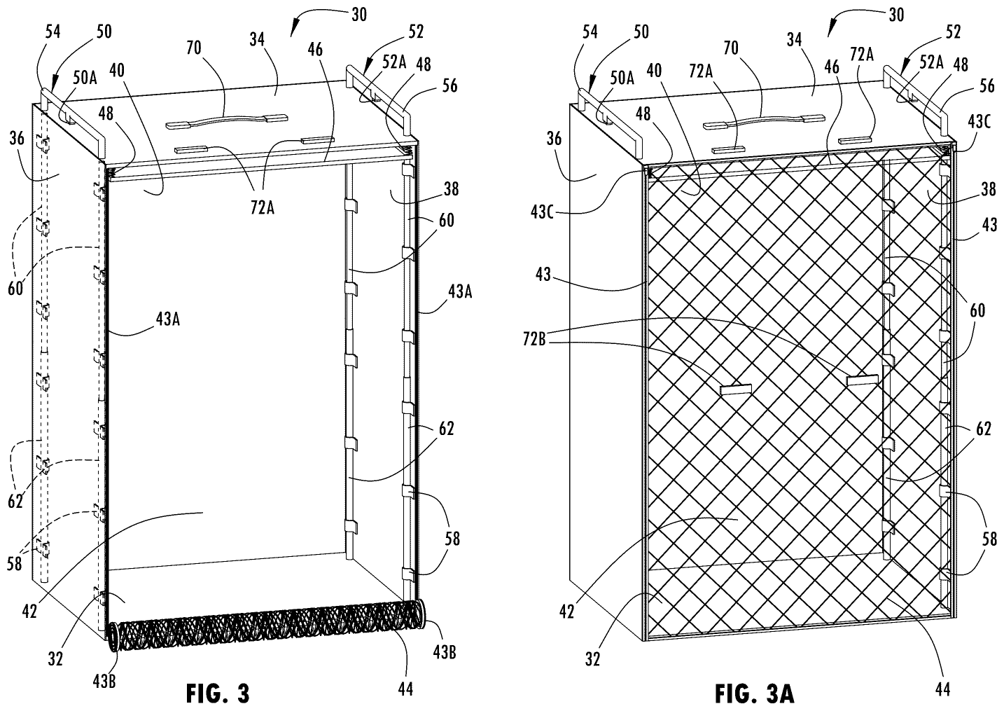

Referring to FIGS. 3 and 3A, the expandable storage compartment 30 is shown in a larger second size expanded configuration in which the first and second telescoping assemblies 50 and 52 are expanded in height, and the left and right sidewalls 36 and 38 and rear wall 40 are expanded in height to extend vertically from top to bottom. The first telescoping assembly 50 has an upper U-shaped tube configured with lower ends to engage lower tubes 60 on the bottom end which extend upwards from the rigid floor 32. Similarly, the second telescoping assembly 52 likewise has a U-shaped tubular assembly extending downward with lower ends engaging lower tubes 62 which extend upward from the floor 32. The lower tubes 62 have a larger diameter defining an opening configured to receive upper tubes 60 which have a smaller outside diameter. Accordingly, the upper tubular assemblies 54 and 56 cooperatively engage within the lower tubes 60 and 62 to allow the telescoping assemblies 50 and 52 to telescope to contract in size and to expand to an enlarged height size as seen in FIGS. 3 and 3A.

The telescoping assemblies 50 and 52 are attached to the corresponding sidewalls 36 and 38 by matingly engaging connector loops 58 provided on the inner surface of the cloth sidewalls 36 and 38. In the example shown, the connecting loops 58 may include sewn fabric material or open loop connected pieces of material that form a loop of a sufficient size to receive and retain the telescoping tubes 60 and 62. It should be appreciated that the telescoping tubes 60 and 62 may otherwise be engaged to support the sidewalls with other connectors.

The net 44 is shown in FIGS. 2A and 3A attached to the front edge of sidewalls 36 and 38 with first and second zippers 43. The net 44 may advantageously be deployed over the entire expanded size front opening 42 to cover the front opening 42 as seen in FIG. 3A. This may be particularly useful when the motor vehicle 10 is transporting one or more larger items. The net 44 may be fully or partially extended across all or a portion of the front opening 42.

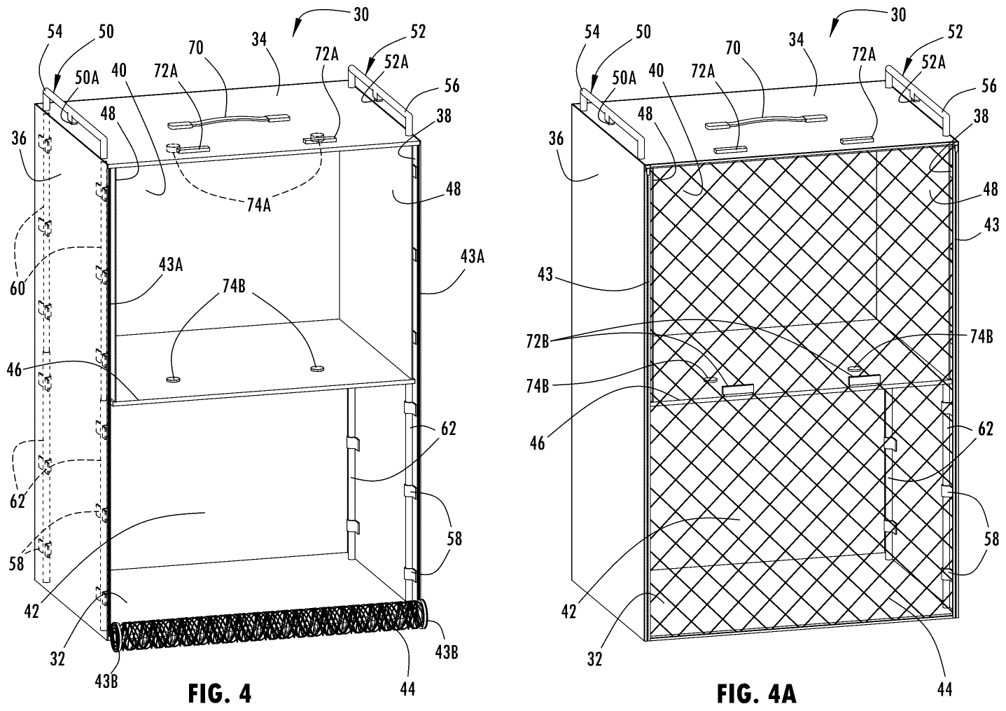

Referring to FIGS. 4 and 4A, the middle shelf 46 may be deployed from the stowed position shown in FIG. 2 to the downward middle shelf use position shown in FIGS. 4 and 4A. When the middle shelf 46 is deployed to the use position, inner sidewalls 48 extend downward to support the middle shelf 46 in a hanging shelf configuration. The middle shelf 46 may include a rigid material, according to one example. The hanging inner sidewalls 48 may be made of a flexible material such as cloth. As such, one or more cargo items may be stored on the middle shelf 46 and supported by the hanging inner sidewalls 48 extending down from the top 34. The middle shelf 46 thereby serves as a divider of the space available within the expandable storage compartment 30. The net 44 may be deployed across the entire open front wall with the middle shelf 46 deployed as seen in FIG. 4A.

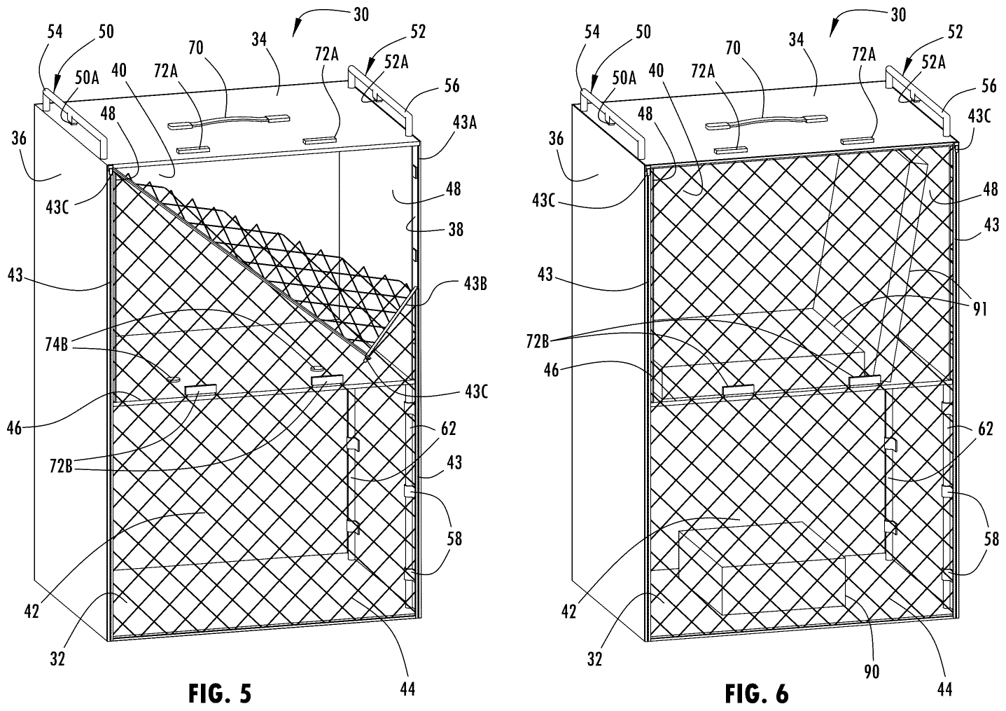

Referring to FIGS. 5 and 6, the expandable storage compartment 30 is further illustrated with the net 44 attached via the zipper 43 on both sides along the front sides of the front opening 42 and partially removed, according to one example. The zipper 43 may include a zipper portion 43A on the sidewall with teeth engageable with teeth on a zipper portion 43B on the net 44 which has zipper ends 43C. It should be appreciated that the net 44 may be rolled up when not in use and may unroll or roll down onto itself on a roller or may otherwise be connected to cover the open front side 42 such as by using hook and loop material (e.g., Velcro®). As seen in FIG. 6, cargo items 90 and 91 may be stowed within the expandable storage compartment 30 which is shown supported on the floor 32 as well as on the middle shelf 46.

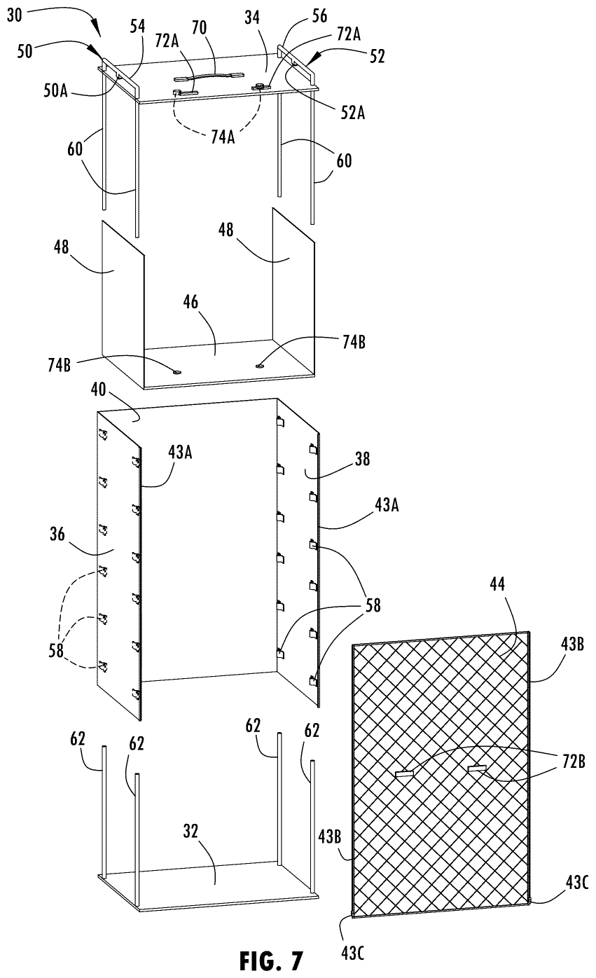

Referring to FIG. 7, the expandable storage compartment 30 is shown in an exploded view with the expanded storage compartment 30 generally exploded from a fully deployed expanded position. As seen, the lower tubes 62 of the telescoping assemblies 50 and 52 may be fixed to the rigid floor 32 and extend upward within the attachment loops 58 in the left and right side walls 36 and 38. The upper tubes 66 of the telescoping assemblies 50 and 52 may extend downward within the attachment loops 58 and may matingly connect with the lower tubes 62 to form the telescoping assembly. In addition, the telescoping assemblies 50 and 52 may each have a release button 50A and 52A provided on top that is spring-loaded and mechanically connected to a releasable connector to allow for the release and attachment of the lower rods 62 to the upper rods 60 to fix the upper and lower tubes 60 and 62 in a desired height position or to allow the upper and lower tubes 60 and 62 to move relative to each other to expand or contract in height. A user may simply depress the buttons 50A and 52A and pull upward or downward on the upper tubular assemblies 54 and 56 to adjust the height of the expandable storage compartment 30.

Accordingly, an expandable storage compartment 30 is advantageously provided for use on a motor vehicle 10 to accommodate storage or holding of cargo items, particularly smaller items, within the vehicle 10. The expandable storage compartment 30 may be located in any of a number of areas in the vehicle 10 and may be adjusted in size to provide for an adjustable height with multiple levels.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. An expandable storage compartment for use on a vehicle, the expandable storage compartment comprising:
an expandable frame comprising a plurality of telescoping assemblies moveable between a contracted configuration and an expanded configuration;
a flexible housing extending around at least a portion of the frame to define a pair of sidewalls and a rear wall that conform to a size of the frame;
a rigid top coupled to the frame and defining a top wall; and
a rigid bottom wall defining a floor and coupled to the frame, wherein the frame and the flexible housing are adjustable between the contracted configuration and the expanded configuration.

2. The storage compartment of claim 1, wherein the frame comprises a first telescoping assembly and a second telescoping assembly.

3. The storage compartment of claim 2, wherein the first telescoping assembly includes a first pair of telescoping tubes and the second telescoping assembly includes a second pair of telescoping tubes.

4. The storage compartment of claim 3, wherein each of the first and second telescoping assemblies include a pair of upper tubes matingly engaging a pair of lower tubes.

5. The storage compartment of claim 4, further comprising a plurality of tube retainers on the pair of sidewalls configured to connect the first and second telescoping assemblies to the pair of sidewalls.

6. The storage compartment of claim 1, further comprising an expandable shelf having flexible sidewalls connected to the rigid top, the shelf moveable between a contracted position stored proximate to a lower surface of the rigid top and an expanded position extending vertically downward from the top and supported by the sidewalls.

7. The storage compartment of claim 6, wherein the flexible sidewalls comprise a fabric.

8. The storage compartment of claim 1, wherein the flexible housing comprises a fabric.

9. The storage compartment of claim 1, further comprising a net provided on a front wall.

10. The storage compartment of claim 8, wherein the net is connected to the flexible material via a zipper.

11. The storage compartment of claim 9, wherein the zipper includes a first zipper and a second zipper on the pir of sidewalls.

12. An expandable storage compartment for use on a vehicle, the expandable storage compartment comprising:
an expandable frame comprising a first and second telescoping assemblies moveable between a contracted configuration and an expanded configuration;
a flexible housing extending around at least a portion of the frame to define a pair of sidewalls and a rear wall that conform to a size of the frame;
a rigid top coupled to the frame and defining a top wall;
a rigid bottom wall defining a floor and coupled to the frame, wherein the frame and the flexible housing are adjustable between the contracted configuration and the expanded configuration; and
an expandable shelf having flexible hanging sidewalls connected to the rigid top, the shelf moveable between a contracted position stored proximate to a lower surface of the rigid top and an expanded position extending vertically downward from the top and supported by the hanging sidewalls.

13. The storage compartment of claim 12, wherein the first telescoping assembly includes a first pair of telescoping tubes and the second telescoping assembly includes a second pair of telescoping tubes.

14. The storage compartment of claim 13, wherein each of the first and second telescoping assemblies include a pair of upper tubes matingly engaging a pair of lower tubes.

15. The storage compartment of claim 14, further comprising a plurality of tube retainers on the pair of sidewalls configured to connect the first and second telescoping assemblies to the pair of sidewalls.

16. The storage compartment of claim 15, wherein the flexible sidewalls comprise a fabric.

17. The storage compartment of claim 12, wherein the flexible housing comprises a fabric.

18. The storage compartment of claim 12, further comprising a net provided on a front wall.

19. The storage compartment of claim 18, wherein the net is connected to the flexible material via a zipper.

20. The storage compartment of claim 19, wherein the zipper includes a first zipper and a second zipper on the pair of sidewalls.
